(19) United States
(12) Patent Application Publication
(10) Pub. No.: US 2012/0291277 A1
(43) Pub. Date: Nov. 22, 2012

(54) METHOD FOR ESTABLISHING A SEALED CONNECTION

(76) Inventors: Gottfried Kain, Bad Goisern (AT); Markus Weber, Bad Goisern (AT)

(21) Appl. No.: 13/512,749

(22) PCT Filed: Dec. 2, 2010
(86) PCT No.: PCT/EP2010/068683

§ 371 Date: Aug. 9, 2012

(30) Foreign Application Priority Data
Dec. 2, 2009 (DE) 10 2009 056 431.4

(51) Int. Cl. H01R 43/00

(52) U.S. Cl. 29/874

(57) ABSTRACT

The invention relates to a method for establishing a sealed connection between two electric conductors, in particular a strand of a carbon brush and a connecting conductor of a supplementary electric component, wherein contact sections (17, 18) of the conductors are exposed by menus of removing a protective sheathing (13, 27) covering the electric conductors, subsequently an electrically conductive connection of the contact sections is generated for forming a connecting site (14), subsequently a slip collar (19) made of shrinkable plastic material is positioned on the connecting site, said slip collar being provided with at least one axial slip opening (26), and subsequently a protective sheathing of the connecting site is formed from the slip collar using a forming process by supplying thermal energy to the slip collar.

The present invention relates to a method for establishing a sealed connection between two electric conductors, in particular a strand of a carbon brush and a connecting conductor of a supplementary electronic component, wherein contact sections of the conductors are exposed by means of removing a protective sheathing covering the electric conductors, subsequently an electrically conductive connection of the contact sections is generated for forming a connection site, subsequently a slip collar made of shrinkable plastic material is positioned at the connection site, said slip collar being provided with at least one axial slip opening, and subsequently a protective sheathing of the connection site is formed from the slip collar in a forming process by supplying thermal energy.

For the connection of electric conductors in a connection site which is exposed to an aggressive environment, further measures usually have to be carried out following the establishment of the actual connection in order to obtain sealing or shielding of the connection site with respect to the surrounding medium. This can take place for example by the fact that such connection sites, following the establishment of the connection which can be constituted for example as a solder joint, are provided with a metallic coating in order to protect the electric conductors. This provision of the shielding or sealing cover of the connection site can easily be produced in the individual case with the known measures, i.e. with the formation of a metallic coating for example.

Particular problems arise, however, when it is a matter of producing a correspondingly shielded or sealed connection site in connection with the large-scale production of components or assemblies, such as is the case for example in the production of carbon brushes which are used on electric fuel pumps operated in motor vehicles, which as fuel pumps are immersed in the fuels commonly used for the operation of motor vehicles. In the case of some fuels, particularly those with ethanol and methanol additives, electro-corrosive, electro-chemical and/or purely chemical attacks on the metallic parts of the pump occur during operation, which can lead to functional impairment and even failure of the pump. This is the case especially with copper strands on carbon brushes, which are sheathed for this purpose in a known manner with a plastic sheathing, for example made of Teflon. For the electrical connection to the copper strand, supplementary components are connected via electric conductors in connection sites at which the copper strand is freed from the shielding sheathing in order to establish the connection, said supplementary components being able to be constituted for example as capacitors or chokes. In the same way as the copper strand, the electric conductors of the supplementary components are freed from any shielding sheathing in the region of the connection site in order to establish a mechanically durable and electrically reliable connection between the strand of the carbon brush and the conductor of the supplementary component.

The problem underlying the present invention is to produce, at a connection site between two electric connectors freed at least partially of their respective shielding on the contact sections in the region of the connection site, subsequent to the actual establishment of the connection by for example soldering, welding or crimping, a shielding or sealing cover of the connection site in as straightforward a manner as possible with a minimum of expenditure, especially handling expenditure.

A method with the features of claim 1 is proposed in order to solve this problem.

In the method according to the invention, the arrangement or formation of a slip collar, which serves for the sealed covering of the connection site, takes place subsequent to the formation of the connection site between the contact sections of the conductors. The method according to the invention is particularly suitable for automated production, since the slip collar can be kept ready as a semi-finished product for the protective sheathing of the connection site directly adjacent to the connection site, said protective sheathing being subsequently formed by a forming operation, and, after the establishment of the connection site, can be pushed easily onto the latter on account of its collar-shaped formation, in order subsequently to be formed, positioned on the spot, into a protective sheathing by means of a forming process. On account of the embodiment of the slip collar with at least one axial slip opening and an advantageous selection of a shrinkable plastic material, preferably a cross-linked polyolefin or PTFE, for the slip collar, exact positioning is possible by a simple axial displacement onto the conductors with subsequent sealing between the slip collar and the protective sheathing of the conductors adjacent in each case to the contact sections. The performance of the forming process by supplying the slip collar with thermal energy can take place as a contactless forming process.

If, according to an advantageous variant of the method, the thermal energy is supplied from the exterior to the slip collar, the thermal energy can be introduced into the slip collar for example in the form of a hot air flow or infrared radiation.

Alternatively, it is also possible to supply the thermal energy from the interior to the slip collar, for example by means of resistance heating by applying a voltage to the electric conductors in the region of the connection site.

The slip collar can have a single-layer wall, so that the protective sheathing formed subsequent to the thermal forming operation is formed by this layer material. It is also particularly advantageous, however, for the protective sheathing of the connection site to be formed by an inner coating of a carrier casing of the slip collar, so that for example the inner coating can be formed by particularly free-flowing materials which enable embedding of the contact sections of the connection site in a particularly easy manner, whereas the carrier casing represents more of an outer reinforcement. In this case, it is also sufficient for the desired fuel resistance of the slip collar or the protective sheathing of the connection site formed after the forming of the slip collar to be provided by the carrier casing, whereas the inner coating does not have to be fuel-resistant and instead can be optimised with regard to its embedding properties.

Especially in the case where the inner coating serves as a cladding compound to form an embedding of the contact sections of the conductors and has a greater chemical resistance to the medium to be shielded against than the carrier casing of the slip collar, the carrier casing can be constituted as a sacrificial casing, which serves solely as a temporary carrier for the material of the inner coating, i.e. the cladding compound, and the carrier casing can be dissolved by the surrounding medium, i.e. the fuel for example, following the forming process and the formation of an embedding which shields the connection site. In this case, therefore, the casing compound ultimately forms the protective sheathing which shields the connection site against the medium.

Depending on whether the conductors, i.e. for example the strand of the carbon brush or the conductor of the supplementary electric component, have unidirectional axial ends, or whether the conductors have axial ends directed towards one another, the slip collar can be provided with only one or with two slip openings.

It an embodiment of the connection site with two unidirectional conductor ends, a slip collar formed hat-shaped is pushed with its axial slip opening disposed opposite the hat base onto the connection site. On account of the hat-shaped embodiment of the slip collar, the positioning of the slip collar with respect to the connection site is unequivocally defined by the stopping of the hat base against the axial conductor ends.

In an embodiment of the connection site with two conductor ends directed against one another, a slip collar formed sleeve-shaped and provided with two slip openings is disposed on a conductor end before the formation of the connection site and after the formation of the connection site is pushed onto the connection site.

Preferred embodiments of the invention are described in greater detail below with the aid of the drawing. In the figures:

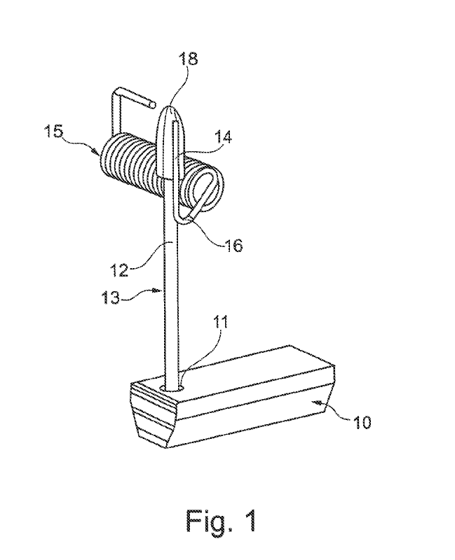

FIG. 1 shows, in an isometric representation, a slip collar formed hat-shaped for the shielding sheathing of a connection site between two unidirectional electric conductors;

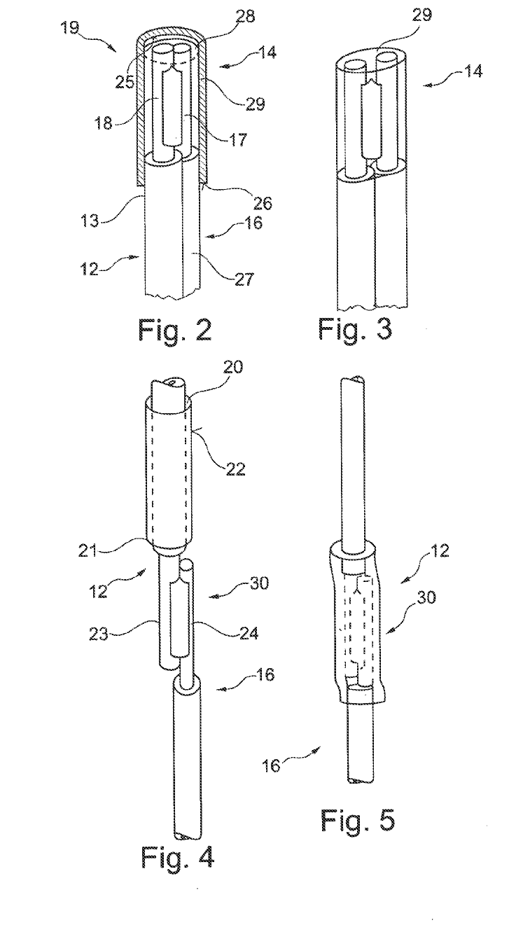

FIG. 2 shows an enlarged representation of the slip collar represented in FIG. 1 in a longitudinal cross-sectional representation;

FIG. 3 shows an alternative embodiment to FIG. 2 of a shielding protective sheathing of a connection site between two unidirectional conductors;

FIG. 4 shows two conductors directed against one another with contact sections contacted to form a connection site directly before positioning of a slip collar;

FIG. 5 shows the connection site represented in FIG. 4 after positioning and forming of the slip collar for the formation of the protective sheathing that shields the connection site.

A preferred embodiment of the invention is represented in FIGS. 1 and 2, which exhibits a strand 12 connected to a carbon brush 10 in a known manner thereby forming a tamped contact 11 or suchlike, said strand being provided with a protective sheathing 13. In the region of connection site 14, a supplementary electric component, in the present case a choke 15, is connected to the axial end of the strand. For this purpose, contact section 17 of a wire conductor 16 of choke 15 is connected to a contact section 18 of strand 12, for example by means of a solder joint, at connection site 14. Connection site 14 is covered by a slip collar 19, which is formed hat-shaped and is pushed onto connection site 14.

The sealing of electrically conductive connection site 14 is produced as follows: the components to be connected, i.e. here contact section 18 of strand 12 and contact section 17 of wire conductor 16, are first connected to one another in an electrically conductive manner by suitable processes, for example by soldering, welding or crimping. In the case of the hat-shaped formation of slip collar 19, the latter is then placed from above onto connection site 14, wherein the positioning of a slip opening 26 lying opposite hat base 25 is defined with respect to connection site 14 by the stopping of hat base 25 against the axial ends of contact sections 17, 18. As can be seen in particular from FIG. 2, it is thus possible to ensure that slip opening 26 of slip collar 19 has a sufficient distance from contact sections 17, 18 exposed free from the sheathing, so that it is ensured in a subsequent shrinkage process of slip collar 19 that a sealing connection is established between slip collar 19 and protective sheathing of strand 12 and a protective sheathing 27 of wire conductor 16.

Diverging from the mode of procedure described above, in the case of a tubular slip collar 22 provided with two slip openings 20, 21, represented in FIGS. 4 and 5, and contact sections 23, 24 of strand 12 and conductor 16 of the supplementary electric component, said contact sections being directed towards one another, slip collar 22 is first pushed over one of the conductors, i.e. over strand 12 or wire conductor 16, and positioned over a connection site 30 only after establishment of the connection, in such a way that contact sections 23, 24 exposed free from the shielding are covered.

As can be seen in particular from FIGS. 2 and 3, depending on the formation and material selection for slip collar 19, an inner coating 28 of carrier casing 29 can be provided, said coating being able to be constituted as an adhesive compound. Coating 29 applied optionally on the inner face of carrier casing 28 can be constituted such that it melts in the course of the shrinkage process of slip collar 19 and forms a cladding compound for the formation of a protective sheathing around contact sections 17, 18 in the region of connection site 14.

Slip collar 19 can be made for example from a polyolefin or PTFE or also FEP and the filling compound can preferably be constituted as an adhesive compound, in particular also fuel-resistant. Especially in the case where the slip collar has particularly good deformation properties, a filling compound can also be dispensed with.

The supply of energy to carry out the shrinkage can take place by the direct or indirect input of thermal energy, as for example by exposure to temperature or radiation, i.e. in particular hot air or infrared radiation.

1. A method for establishing a sealed connection between two electric conductors, said method comprising:
exposing contact sections of the conductors by removing a protective sheathing covering the electric conductors;
forming a connection site by electrically connecting the contact sections;
positioning a slip collar made of a shrinkable plastic material at the connection site, said slip collar being provided with at least one axial slip opening; and
forming a protective sheathing of the connection site from the slip collar in a forming process by supplying thermal energy.

2. The method according to claim 1, in which the thermal energy is externally supplied to the slip collar.

3. The method according to claim 1, in which the thermal energy is internally supplied from to the slip collar.

4. The method according to claims 1, in which the protective sheathing of the connection site is formed by an inner coating of a carrier casing of the slip collar.

5. The method according to claim 4, in which a cladding compound embedding the connection site following the forming process of the protective sheathing from the slip collar is used as the inner coating of the carrier casing.

6. The method according to claim 5, in which the cladding compound has a greater chemical resistance to medium to be shielded compared to the carrier casing of the slip collar, in such a way that the carrier casing is constituted as a sacrificial casing.

7. The method according to claim 1, in which, in the case of a formation the connection site with two unidirectional conductor ends, a hat-shaped slip collar having a hat base and an axial slip opening disposed opposite the hat base is pushed onto the connection site.

8. The method according to claim 1, in which, in the case of a formation of the connection site with two conductor ends directed against one another, a sleeve-shaped slip collar having two axial slip openings is disposed on a conductor end before the formation of the connection site and after the formation of the connection site the slip collar is pushed onto the connection site.
